(19) United States
(12) Patent Application Publication
(10) Pub. No.: US 2012/0041862 A1
(43) Pub. Date: Feb. 16, 2012

(54) COMPUTERIZED MARKETPLACE FOR RATIO BASED DERIVATIVES

(75) Inventors: Gil BUL, Kfar Hess (IL); Assaf SEGAL, Tel Aviv (IL); Yuval PERLOV, Tel Aviv (IL); Eran SHERIFF, Tel Aviv (IL)

(73) Assignee: NEXTRADE LTD, Tel-Aviv (IL)

(21) Appl. No.: 13/205,719

(22) Filed: Aug. 9, 2011

Related U.S. Application Data
(60) Provisional application No. 61/372,890, filed on Aug. 12, 2010.

(51) Int. Cl. G06Q 40/00

(52) U.S. Cl. 705/37

(57) ABSTRACT

A computerized marketplace for ratio-based derivatives is provided herein. A method implementing the marketplace includes the following stages: receiving a price query related to a selected derivative on two selected underlying assets, defining a ratio of their respective prices in a specified order, at a specified timestamp; applying a pricing algorithm to the query, to yield an ad hoc return or price of the derivative, relevant to the specified timestamp, wherein the price of the option (or return) is based on an estimated relative financial market performance of the selected underlying assets; and presenting the ad hoc price (or return) of the selected option, wherein at least one of: the receiving, the applying, and the presenting is executed by at least one processor.

### BACKGROUND

1. Technical Field

The present invention relates to computerized trading and more particularly, to a computerized platform that enables trading of options.

2. Discussion of the Related Art

The development and expansion of computer networks over the past three decades has given rise to computer-based security trading, also known as electronic trading. Over that time, electronic investing greatly expanded and has become the norm for professional traders and individual investors alike. Most, if not all brokerages currently offer online services with unique trading platforms. These trading platforms are essentially client server applications, which allow their users—financial institutions, brokers, or private investors—to perform research and place trading orders.

Typically, such trading platforms utilize a Graphical User Interface (GUI) at the client's side. Apart from placing trade orders, these GUI commonly offer research and analysis tools aimed at assisting the user-investor with trading.

### BRIEF SUMMARY

One aspect of the present invention provides a method for pricing novel financial derivative securities (e.g. options), which are based on the relative performance of two underlying assets. A method for implementing the invention may include the following steps: receiving a price query relating to a selected option on two underlying assets (in a specified order) at a specified timestamp; applying a pricing algorithm to the query to yield an ad hoc price (or return) for the option relevant to the specified timestamp, wherein the price may be based on a projected performance of the underlying assets or some other valuation technique; and presenting the ad hoc price (or return) for the option.

Another aspect of the invention may include a system arranged to execute the aforementioned method and a computer readable program configured to execute the aforementioned method.

Yet another aspect of the invention may include a system and/or a computer readable program configured to enable trading of the aforementioned derivative securities.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of possible embodiments of the invention and to show how the same may be carried into effect, reference will now be made, purely by way of example, to the accompanying drawings, in which like numerals designate corresponding elements or sections throughout.

In the accompanying drawings:

FIG. 1 is a high level schematic block diagram illustrating an environment of a system according to some embodiments of the invention;

FIG. 2 is a high level flowchart diagram illustrating a method according to some embodiments of the invention; and

FIG. 3 are GUI diagrams illustrating some aspects of an example embodiment of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “derivative” as used herein refers to a financial instrument—or more simply, an agreement between two parties—whose value is determined by the price of some other asset(s), commonly referred to as the underlying asset(s). In other words, it is a financial contract whose value is linked to the price (or value) of its underlying asset(s). The underlying asset may be a share, an index, a currency or any other asset whose value can be determined by some method acceptable to the parties involved in trading the derivative contract. There are many kinds of derivatives, the most notable being swaps, futures, and options. Moreover, since a derivative can be written on any sort of asset or assets, the variety of possible derivatives is virtually endless. Thus, we adopt a general definition in which a derivative is an agreement between two parties whose value is contingent on the future behavior and/or outcome of its underlying asset(s).

The term “option” as used in this application refers to a financial instrument that gives its owner the right, but not the obligation, to engage in some specific transaction, based on the future behavior and/or outcome of some asset(s), e.g. buying or selling the asset(s) at some predetermined price. We note that such transactions do not necessitate actual trading of the underlying asset(s), and may instead be conducted by transaction of some equivalent asset, e.g. cash.

Options are derivative instruments, as their fair price derives from the behavior and/or value of their underlying assets. The underlying is commonly a stock, a bond, an index or a futures contract, though other types of options exist, and options can in principle be created for any type of asset (as long as a value can be ascribed to that asset in a manner acceptable to the parties entering the contract). An option to buy something is commonly referred to as a call option (or simply a call); an option to sell is called a put option (or simply a put). The price specified, at which the underlying may be traded is denoted the strike price. The process of activating an option and thereby trading the underlying at the agreed-upon price is referred to as exercising it. Most options have an expiration date. If the option is not exercised by the expiration date, it becomes void and worthless. Options enabling their holder to exercise any time prior to expiration are commonly referred to as American. Options enabling exercise only at expiration are referred to as European.

The term “ratio option”, as used herein, refers to an option whose value is contingent on the relative performance of two underlying assets; that is, the financial performance of one asset vis-à-vis the financial performance of another asset, wherein each of the two assets may be a stock share, a bond, an index, a futures contract, a swap or any other asset or group of assets whose value can be determined in a manner acceptable to the parties involved in trading the option. Similar to standard options, a ratio option contract typically specifies its expiration time, a strike, a payoff function and the time-window wherein the option may be exercised.

The term “return” as used herein, refers to the return on investment (ROI), typically quoted in percent, which may be calculated by the following expression:

$$100 * ( \frac{p}{i} - 1 ) ,$$

wherein p is the payout from an investment and i is the invested amount.

With specific reference now to the drawings in detail, it is stressed that the particulars shown are by way of example and for purposes of illustrative discussion of some preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice.

Before explaining at least some embodiments of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

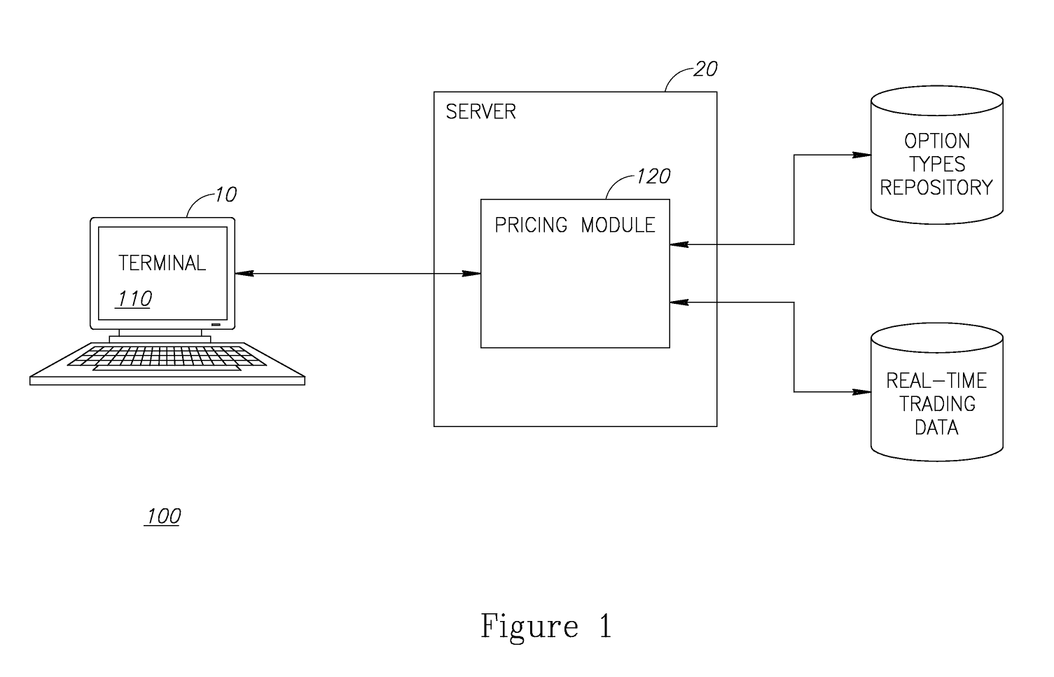

FIG. 1 is a high level schematic block diagram illustrating an environment of a system according to some embodiments of the invention. System 100 is implemented within a computer network such as the Internet and includes a server 20 in communication with a terminal 10. Server 20 is further in communication with real-time data repository (not shown) which is updated periodically by, for example, the stock exchange network (not shown). A graphical user interface (GUI) 110 is associated with terminal 10, while a pricing module 120 serves as a backend module within server 20.

In operation, GUI 110 is configured to transmit a price query related to a selected ratio option at a specified timestamp, while pricing module 120 is configured to apply a valuation algorithm to the query, to yield an ad hoc price for the option, relevant to the specified timestamp. The value of the selected ratio option is computed, based on data read from the trading data repository 30 (which may utilize real-time market data). GUI 110 is then configured to present the ad hoc price of the selected option. System 100 may further serve as a real-time platform for trading the ratio options and any financial transaction carried out in conjunction with such trading

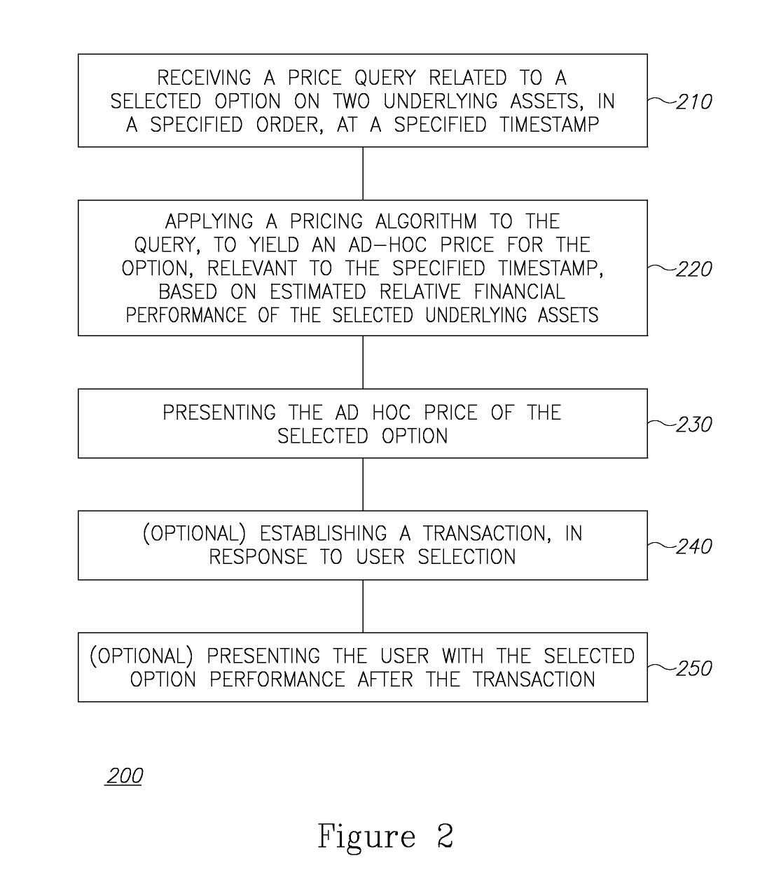

FIG. 2 is a high level flowchart diagram illustrating a method according to some embodiments of the invention. Method 200 may include the following steps: receiving a price query related to a selected ratio option (i.e. an option on two selected underlying assets in a specified order) at a specified timestamp 210; applying a pricing algorithm to the query, to yield an ad hoc price for the option, relevant to the specified timestamp, wherein the price is based on projections and/or estimates of the relative performance of the selected underlying assets; and presenting the ad hoc price for the selected option 230.

Method 200 may allow the user to complete a transaction by establishing a buy or sell order in response to the user selection 240 and may also allow the user to monitor the performance of the selected option along with its underlying assets 250.

Consistent with some embodiments of the invention, the relative financial performance is based, at least in part, on the returns of the underlying assets over some specified period of time.

Consistent with some embodiments of the invention, the options are selected from a set of existing options of predetermined characteristics.

Consistent with some embodiments of the invention, the underlying assets are at least one of: stocks, commodities, financial indices, financial indicators, any financial instrument exhibiting publicly known market prices, or any other asset whose value and/or performance can be determined by some method acceptable to the parties involved in trading the contract.

Consistent with some embodiments of the invention, the financial performance of the underlying assets is received, possibly in real time, from actual market data.

Consistent with some embodiments of the invention, monitoring of the derivative (e.g. an option) as well as its underlying assets continues, at some appropriate refresh rate, over a specified period of time, e.g. throughout the lifetime of the derivative.

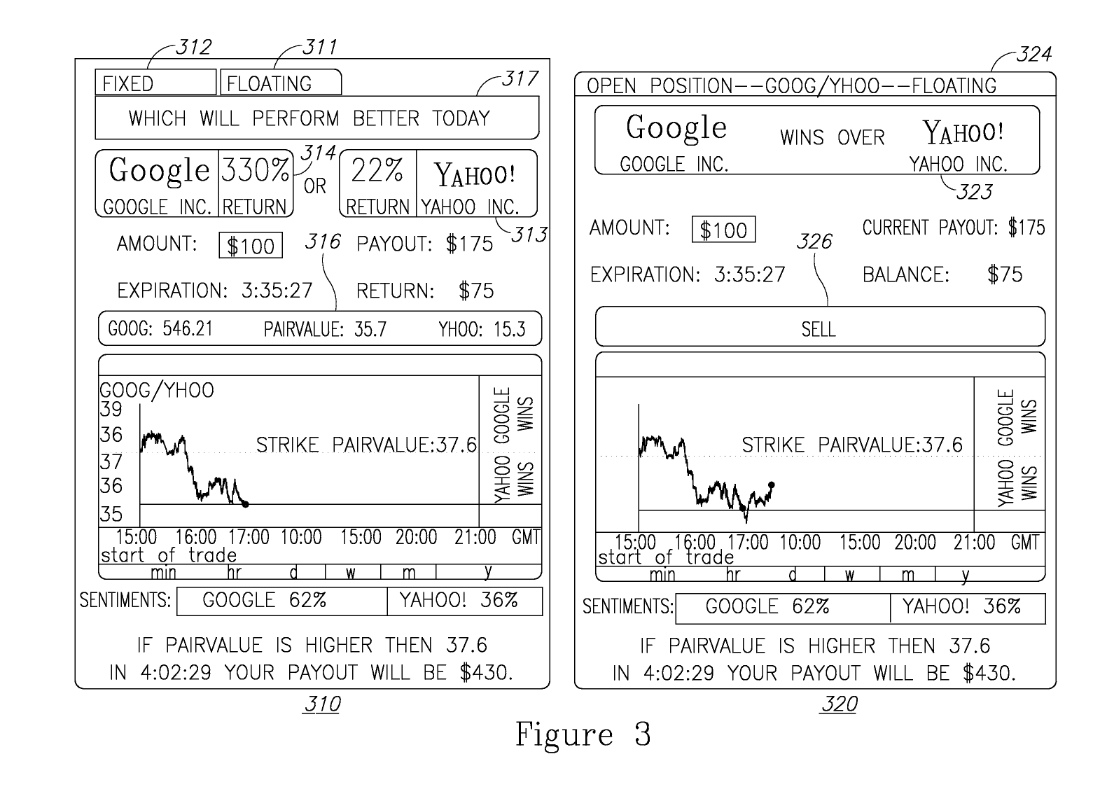

FIG. 3 shows GUI diagrams illustrating several features pertaining to some practicable embodiments of the invention. Screenshot 310 shows two stocks, 313 and 314 (and respective returns) and a graph showing the ratio between the prices of these stocks over time. The current-time price ratio (i.e. spot ratio) of the underlying pair of stocks is shown in 316.

Some embodiments of the invention may offer the user to select two methods for setting the option strikes: Struck at Predetermined Time (SPT), in which the option strike is determined, according to some criteria, at some specified time, typically before but possibly after the trade is made; Struck at Trade (SAT) type, in which the strike is determined, according to some criteria (e.g. price ratio of the underlying assets), at the time of trade.

Specifically, the user may select from several types of options, such as SPT 312 and SAT 311 described above, and send a query for their price. Screenshot 320 refers to a situation wherein the user has already made a buy order and may now monitor the performance over time of his or her open position 323 or 324, and may also close the position by selling at any point, using sell button 326.

Consistent with some embodiments of the invention, detailed below are some non-limiting pricing principles that may be used during the pricing stage. It is understood that other pricing models/methods may be employed in order to carry out the present invention.

An illustrative pricing model, which may be applied, relies on modifications of known frameworks for option valuation, such as the Black-Scholes (BS) model, in order to make them compatible with a ratio-based underlying, as discussed below. The modified models may be implemented using either closed-form, where applicable, or numerical methods, such as Monte-Carlo simulation, lattice or tree.

The starting point of the analysis is a two-asset Ito's lemma, which is, essentially, a two variable first-order Taylor expansion, modified to take into account the stochasticity of the variables, which we exemplify below by looking at stock prices, although the method we describe herein may be utilized, possibly with required adjustments, for other types of assets. A general second order Taylor expansion for a function φ of two stochastic variables X₁ and X₂ is given by:

$$d φ = \frac{\partial φ}{\partial {X}_{1}} d {X}_{1} + \frac{\partial φ}{\partial {X}_{2}} d {X}_{2} + \frac{1}{2} E [ {\sum }_{i = 1}^{2} {\sum }_{j = 1}^{2} \frac{{\partial }^{2} φ}{\partial {X}_{i} \partial {X}_{j}} d {X}_{i} d {X}_{j} ]$$

(Note: Higher orders of the expansion are ignored, as is customary in the financial industry.)

For φ which is a quotient of two stochastic variables, X₁, X₂, i.e.

$$φ \to φ ( \frac{{X}_{1}}{{X}_{2}} ) ,$$

we get by substitution:

$$d ( \frac{{X}_{1}}{{X}_{2}} ) = ( \frac{{X}_{1}}{{X}_{2}} ) \{ \frac{d {X}_{1}}{{X}_{1}} - \frac{d {X}_{2}}{{X}_{2}} + E [ ( \frac{d {X}_{2}}{{X}_{2}} ) ( \frac{d {X}_{2}}{{X}_{2}} ) ] - E [ ( \frac{d {X}_{1}}{{X}_{1}} ) ( \frac{d {X}_{2}}{{X}_{2}} ) ] \}$$

The expression above, allows one to modify models for the stochastic behavior of the price of some given class of stochastic financial assets (e.g. stocks) so that they may be utilized to model a ratio of two assets. Note that X₁ and X₂ are not required to follow identical stochastic behaviors.

The above derivation is exemplified for a case wherein X₁ and X₂ are both stocks, asserting that this method is applicable to other cases and asset types. The most widely used model for stock price behavior is the Ito process, i.e. dXᵢ=Xᵢμᵢdt+XᵢσᵢdWᵢ where μ is the instantaneous expected drift, σ the volatility, and dW the change over an infinitesimal time dt of a variable W, which follows a Wienner process (also called Brownian motion). This process demonstrates an instantaneous expected drift rate μX and instantaneous variance rate σ²X². Substituting the above expression for stock price into Ito's lemma, modified for quotients, we obtain:

$$d ( \frac{{X}_{1}}{{X}_{2}} ) = ( \frac{{X}_{1}}{{X}_{2}} ) \{ {μ}_{1} - {μ}_{2} + {σ}_{2}^{2} - {σ}_{1} {σ}_{2} {ρ}_{1 , 2} \} d t + ( \frac{{X}_{1}}{{X}_{2}} ) \{ {σ}_{1} d {W}_{1} - {σ}_{2} d {W}_{2} \}$$

That is, the process for the quotient of two Ito processes is an Ito process with an “effective drift”: μ̅=μ₁−μ₂+σ₂²−σ₁σ₂ρ_{1, 2} and a stochastic term which can be rewritten as: σ̅dW, where the “effective volatility” σ̅, is given by: σ̅=\sqrt{σ₁²+σ₂²−2ρ_{1, 2}σ₁σ₂}, where ρ_{1, 2} is the correlation between X₁ and X₂ and dW a standard Wiener process.

The above method allows modifying models of a single stochastic variable, to apply to the quotient of two stochastic variables. Expressions different from the one presented above may be obtained in cases wherein the underlying assets follow some process different than the Ito process.

Consistent with some embodiments of the invention, model parameter estimates, e.g. for μ, σ, ρ may be calculated automatically, for example off of market data. Calculated parameters may be monitored and verified by a trading/risk manager for plausibility, especially when events which may significantly affect the behavior of the underlying, e.g. distribution of dividends, financial reporting, press release, acquisition occur.

Consistent with some embodiments, the price presented to users may contain a varying spread, in order to take into account factors such as parameter uncertainties, dividend uncertainty, and exposure to foreign exchange rates.

Consistent with some embodiments of the invention, a European digital option may be offered. In such embodiments the user may enter a transaction wherein he or she pays an amount prem and selects (e.g. from a list of asset-pairs) an asset, which he or she believes would outperform (in terms of return) another asset, over a predetermined time period. At expiry (or at some other predetermined time) a comparison is made between the performance, of the two assets over the predetermined time period, The buyer is entitled to receive a fixed amount P in case he or she chose correctly or p otherwise, where, typically P>p.

The following is a non-limiting formal representation of the pricing process for embodiments such as the one described above: Let A and B denote two stocks, which are the underlying assets in this example. Let T denote the time interval (measured in years) from the time the transaction is made (i.e. an option is bought) till expiry; Let S_{A}(t) and S_{B}(t) denote the respective spot prices for stock A and stock B at time t. Suppose the initial time T₀=0. Assume that in this example the buyer chose stock B as the better performer. Further, assume the payout is made in the currency the stocks are traded in.

When the option expires the holder is paid:

$$payout = \{ \begin{matrix}P & \frac{{S}_{B} ( T )}{{S}_{B} ( 0 )} > \frac{{S}_{A} ( T )}{{S}_{A} ( 0 )} \\ p & otherwise\end{matrix} \qquad ( 1 )$$

The above condition can be rearranged as:

$$\frac{{S}_{B} ( T )}{{S}_{A} ( T )} > X ≡ \frac{{S}_{B} ( 0 )}{{S}_{A} ( 0 )}$$

where X, defined as the ratio between S_{A}(0) and S_{B}(0). Depending on the time-window over which the performance is measured, X may be known at the time the transaction is entered.

Digital ratio options such as those delineated in the example above may be priced by utilizing the ratio-derivatives valuation method described above. The BS framework is easily modifiable for pricing of standard European digital options. Further adaptation of BS for European digital options, for valuation of ratio options is attained by replacing the conventional BS drift μ and volatility σ by their ratio-option-adjusted “effective” equivalents defined above, μ̅ and σ̅.

Utilizing a modified-BS valuation, as suggested above, offers a simple, closed-form, solution for several types of options, yet may leave several practical challenges. For example, empirical studies indicate that the price behavior of stocks deviates from the Ito process, which is used in BS. For example, consistent with market observations, some suggest models wherein σ (the volatility) isn't a constant, but rather depends on factors such as the option strike and time to expiry. However, the method given above for modifying single asset models into models suitable for asset ratios isn't limited to the BS framework, and thus other single-asset models may be utilized by applying similar modifications.

For example, some embodiments of the invention may utilize binomial-tree-based valuation methods, which allow implementation of non-constant volatility and non-Ito behavior. In such cases, the above described modification is applied to the defining equations of the tree, to give: pu+(1−p)d=e^{ūΔt} for the expected value, \sqrt{p(1−p)}log(u/d)= σ̅\sqrt{Δt} for the volatility, and ud=e^{2cΔt} (with c a constant) for the centering condition. In these expressions p is the probability of upward transition on the tree, u, d the value-factors used for upward and downward movements respectively. μ̅ and σ̅ are the “effective” parameters for the ratio of two stochastic processes, as discussed above.

For instance, embodiments of the invention that choose to valuate options by utilizing a Cox-Ross-Rubinstein type tree would use an up price ratio of u=e ^{σ̅\sqrt{Δt}} where σ̅ is the effective volatility, as described above, a down price ratio of d=1/u and a transition probability

$$p = \frac{{e}^{\overline{μ} Δ t} - d}{u - d} ,$$

where μ̅ is the effective drift, as described above.

In some embodiments, e.g. for trading purposes, a spread may be applied over the theoretical price. The following is a non-limiting list of factors which may be taken into account in calculations of the spread size:
Market supply and demand: spreads may be used to control demand for given instruments.
Parameter uncertainty: spreads may be used to control risk associated with parameter uncertainty.
Current position of market-maker: Spreads may be used to control the risk-exposure of the market-maker.
Liquidity: Spreads may be used to control the volume and liquidity of given traded instruments
Investor-specific: Spreads may vary according to investor characteristics, e.g. spreads may be lowered for favored investors.

Calculation of the size of the spread may be attained by a method separate from the method/algorithm used for pricing.

As will be appreciated by one skilled in the art, aspects of the present invention may be embodied as a system, method or computer program product. Accordingly, aspects of the present invention may take the form of an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer-readable medium(s) may be utilized. The computer readable medium may be a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Program code embodied on a computer-readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

Aspects of the present invention are described above with reference to flowchart illustrations and/or block diagrams of methods, apparatuses (systems) and computer program products, according to embodiments of the invention. It is to be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data-processing apparatus, to produce a machine, such that the instructions, which execute via the processor of the computer or other programmable data processing apparatus, create means for implementing the functions/instructions specified in the flowchart and/or block diagram block or blocks.

These computer-program instructions may also be stored in a computer readable medium that can direct a computer, other programmable data processing apparatus, or other devices to function in a particular manner, such that the instructions stored in the computer-readable medium produce an article of manufacture including instructions which implement the function/instructions specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process, such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products, according to various embodiments of the present invention. In this regard, each block in the flowchart or block diagrams may represent a module, segment, or portion of code, which comprises one or more executable instructions for implementing the specified logical function(s). It should also be noted that in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “some embodiments,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “some embodiments” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and apparatuses equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising:
receiving a price query for a selected derivative on two underlying assets defining a ratio of their respective prices in a specified order at a specified timestamp;
applying a pricing algorithm to the query, to yield an ad hoc price for the derivative relevant to the specified timestamp, wherein the price of the derivative is based on an estimated relative financial performance of the selected underlying assets; and
presenting the ad hoc price of the selected derivative,
wherein at least one of: the receiving, the applying, and the presenting is executed by at least one processor.

2. The method according to claim 1, wherein the relative financial performance is based on a change over time in the ratio between the prices or values, as determined by a method acceptable to both parties entering the transaction of the two underlying assets.

3. The method according to claim 1, wherein the relative financial performance is based, at least in part, on the returns presented by each of the underlying assets over some predefined time periods.

4. The method according to claim 1, wherein the underlying assets are at least one of: stocks, commodities, bonds, financial indices, financial indicators, or any asset or financial instrument having publicly known market prices, or whose value and/or performance may be determined by methods acceptable to the parties entering the transaction.

5. The method according to claim 1, wherein the financial performance of the underlying assets may be received in real time from actual market data pertaining to these underlying assets, or derived in any other means acceptable to the parties entering the transaction.

6. The method according to claim 1, wherein monitoring of the performance of the derivative as well as its underlying assets continue, at some appropriate refresh rate, over a specified period of time, throughout a lifetime of the derivative.

7. The method according to claim 1, further comprising establishing an online marketplace enabling users to carry out financial transactions based on the derivatives.

8. A system comprising:
a processor;
a graphical user interface (GUI) executed by the processor; and
a backend module executed by the processor, and further in communication with the GUI,
wherein the GUI is configured to send a price query relating to a selected derivative on two selected underlying assets, defining thus a ratio of their respective prices, in a specified order, at a specified timestamp,
wherein the backend module is configured to apply a pricing algorithm to the query, to yield an ad hoc price for the derivative relevant to the specified timestamp; wherein the price of the derivative is based on an estimated relative financial performance of the selected underlying assets, as determined by market data, or any other method acceptable to the parties entering the transaction, and
wherein the GUI is further configured to present the ad hoc price of the selected option.

9. The system according to claim 8, wherein the relative financial performance is based, at least in part, on a change over time in the ratio between the prices, or values, as determined by market data or any other method acceptable to the parties entering the transaction, of the underlying assets.

10. The system according to claim 8, wherein the relative financial performance is based at least partially on which of the underlying assets have presented what returns over some predetermined period of time.

11. The system according to claim 8, wherein the derivatives e.g. options are selected from a set of existing derivative types of predetermined characteristics.

12. The system according to claim 8, wherein the underlying assets are at least one of: stocks, commodities, bonds, financial indices, financial indicators, or any asset or financial instrument exhibiting publicly known market prices, or whose value or performance may be determined by methods acceptable to the parties entering the transaction.

13. The system according to claim 8, wherein the financial performance of the underlying assets is received by the backend module in real time from actual market data pertaining to the underlying assets, or determined by any other method acceptable to the parties entering the transaction.

14. The system according to claim 8, wherein the GUI may be further configured to repeatedly refresh, presenting an updated price for the selected derivative over a specified period of time.

15. The system according to claim 8, further comprising an online marketplace platform configured to enable users to carry out financial transactions based on the derivatives.

16. A computer program product comprising:
a computer readable storage medium having computer readable program embodied therewith, the computer readable program comprising:
computer readable program configured to receive a price query relating to a selected derivative on two selected underlying assets defining a ratio of their respective prices as observed in the market or determined in some agreed-upon manner, in a specified order at a specified timestamp;
computer readable program configured to apply a pricing algorithm to the query, to yield an ad hoc price for the derivative, relevant to the specified timestamp, wherein the price of the derivative, is based, at least in part, on an estimated relative financial performance of the selected underlying assets; and
computer-readable program configured to present the ad hoc price for the selected derivative.

17. The computer program product according to claim 16, wherein the relative financial performance is based, at least partially, on the returns of each of the underlying assets over a specified period of time, or on some other predetermined observable behavior of which.

18. The computer program product according to claim 16, further comprising computer readable program configured to enable selection of the derivatives from a group of existing derivative types of predetermined characteristics.

19. The computer program product according to claim 16, wherein the underlying assets are at least one of: stocks, commodities, bonds, financial indices, financial indicators, or any asset or financial instrument exhibiting publicly known market prices, or whose value or performance may be determined by methods acceptable to the parties entering the transaction.

20. The computer program product according to claim 16, further comprising computer readable program configured to receive the financial performance of the underlying assets in real time from actual market data, or derive it by other means, acceptable to the parties entering the transaction.

21. The computer program product according to claim 16 further comprising computer-readable program configured to repeatedly update, to present the price and/or performance of at least one of: the selected derivative and underlying assets over a specified period of time in a visual format.

22. The computer program product according to claim 16 further comprising computer-readable program configured to enable users to carry out financial transactions based on the derivatives.
